(19) United States
(12) Patent Application Publication
(10) Pub. No.: US 2026/0180471 A1
(43) Pub. Date: Jun. 25, 2026

(54) POWER CONVERSION DEVICE

(71) Applicant: TMEIC Corporation, Tokyo (JP)

(72) Inventors: Ryo MURATA, Chuo-ku (JP); Tomohiro TANAKA, Chuo-ku (JP)

(73) Assignee: TMEIC Corporation, Tokyo (JP)

(21) Appl. No.: 19/127,579

(22) PCT Filed: Oct. 18, 2023
(86) PCT No.: PCT/JP2023/037704

§ 371 Date: May 6, 2025

(51) Int. Cl. H02M 7/5387

(52) U.S. Cl. CPC H02M 7/5387

(57) ABSTRACT

A power converter includes first and second switching elements connected in series between first and second DC lines, third and fourth switching elements connected in series between the second DC line and a third DC line, an AC terminal, and a multilevel circuit. The multilevel circuit is connected between a first point of connection between the first and second switching elements and a second point of connection between the third and fourth switching elements, and the AC terminal. A filter includes a reactor having a first terminal connected to the AC terminal, and a capacitor connected between a second terminal of the reactor and the second DC line. The multilevel circuit mutually converts a first DC voltage received by the first point of connection and a third DC voltage received by the second point of connection, and a first AC voltage having at least five voltage values.

### TECHNICAL FIELD

The present disclosure relates to a power conversion device.

### BACKGROUND ART

For example, WO 2010/044164 (PTL 1) discloses an uninterruptible power supply device including a converter, an inverter, a direct-current (DC) voltage converter, an input filter, and an output filter.

The converter converts alternate-current (AC) power supplied from an AC power supply via an input filter into DC power. The inverter converts the DC power from the converter into AC power. The AC power from the inverter is supplied to a load via the output filter. The input filter and the output filter are each an LC filter circuit constituted of a reactor and a capacitor.

The converter and the inverter are connected via a DC positive bus, a DC negative bus, and a DC neutral point bus. The DC voltage converter mutually converts a DC voltage between the DC positive bus and the DC negative bus, and a voltage of a storage battery. The converter, the inverter, and the DC voltage converter are each constituted of a three-level circuit.

### CITATION LIST

### Patent Literature

PTL 1: WO 2010/044164

### SUMMARY OF INVENTION

### Technical Problem

The conventional uninterruptible power supply device, in which the converter and the inverter are each constituted of a three-level circuit, can have smaller harmonics caused by operations of the converter and the inverter than when the converter and the inverter are each constituted of a two-level circuit. Thus, the inductance of each reactor included in the input filter and the output filter can be reduced, thus miniaturizing the reactor. In addition, the three-level circuit can have a smaller voltage applied to a single semiconductor switching element than the two-level circuit, thus reducing switching losses caused in the semiconductor switching elements. This can reduce power losses of the converter and the inverter.

Further, the DC voltage converter is constituted of the three-level circuit, reducing the inductance of the reactor included in the DC voltage converter to miniaturize the reactor.

However, in order to further improve the efficiency of the uninterruptible power supply device, it is required to reduce power losses in the converter and the inverter and iron losses of the reactors in the input filter and the output filter.

In the conventional uninterruptible power supply device, power losses of the converter and the inverter can be further reduced by applying multilevel circuits, which can output more voltage levels than the three-level circuit, such as a five-level circuit. However, if the multilevel circuit is configured to divide a DC input voltage equally by a plurality of capacitors, the circuit configuration of the DC voltage converter may become more complicated in order to compensate for the imbalance in the voltage across the plurality of capacitors.

The present disclosure has been made to solve the above problem. An object of the present disclosure is to provide a high-efficiency power conversion device while avoiding increasing complexity of a circuit configuration.

### Solution to Problem

A power conversion device according to an embodiment of the present disclosure includes first to third DC lines, a first capacitor, a second capacitor, a power converter, and a filter. The first capacitor is connected between the first and second DC lines. The second capacitor is connected between the second and third DC lines. The power converter is configured to mutually convert first to third DC voltages respectively supplied from the first to third DC lines and a first AC voltage having at least five voltage values. The filter removes a harmonic caused by the power converter. The power converter includes first and second switching elements connected in series between the first and second DC lines, third and fourth switching elements connected in series between the second and third DC lines, an AC terminal that receives the first AC voltage, and a first multilevel circuit. The first multilevel circuit is connected between the AC terminal, and a first point of connection and a second point of connection, the first point of connection being a point of connection between the first and second switching elements, the second point of connection being a point of connection between the third and fourth switching elements. The filter includes a first reactor having a first terminal connected to the AC terminal, and a third capacitor connected between a second terminal of the first reactor and the second DC line. The first multilevel circuit mutually converts the first AC voltage, and the first and third DC voltages, the first DC voltage being received by the first point of connection, the third DC voltage being received by the second point of connection.

### Advantageous Effects of Invention

According to the present disclosure, a high-efficiency power conversion device can be provided while avoiding increasing complexity of a circuit configuration.

### BRIEF DESCRIPTION OF DRAWINGS

FIG. 1 is a block diagram showing an overall configuration of an uninterruptible power supply device to which a power conversion device according to an embodiment of present disclosure is applied.

FIG. 2 is a circuit diagram showing an example configuration of a converter and its peripherals.

FIG. 3 is a circuit diagram showing an example configuration of an inverter and its peripherals.

FIG. 4 is a circuit diagram showing an example configuration of a DC voltage converter.

FIG. 5 is a functional block diagram showing an example configuration for controlling the converter.

FIG. 6 is a functional block diagram showing an example configuration for controlling the DC voltage converter.

FIG. 7 is a functional block diagram showing an example configuration for controlling the inverter.

FIG. 8 is a functional block diagram of a PWM circuit.

FIG. 9 is a time chart showing waveforms of a voltage command value, a carrier wave, a gate signal, and a voltage generated at an output node of the inverter.

FIG. 10 is a diagram for illustrating the correspondence between a switching pattern of an IGBT and a voltage generated at the output node of the inverter.

FIG. 11 is a circuit diagram showing an operation in each mode shown in FIG. 10.

FIG. 12 is a circuit diagram showing an operation in each mode shown in FIG. 10.

FIG. 13 is a circuit diagram showing an example configuration of the inverter and its peripherals.

FIG. 14 is a circuit diagram showing an example configuration of the inverter and its peripherals.

FIG. 15 is a circuit diagram showing an operation in each mode of the inverter.

FIG. 16 is a circuit diagram showing an operation in each mode of the inverter.

FIG. 17 is a circuit diagram showing an example configuration of the inverter and its peripherals.

### DESCRIPTION OF EMBODIMENTS

An embodiment of the present disclosure will be described below in detail with reference to the drawings. The same or corresponding parts in the figures have the same reference characters allotted, and description thereof will not be repeated.

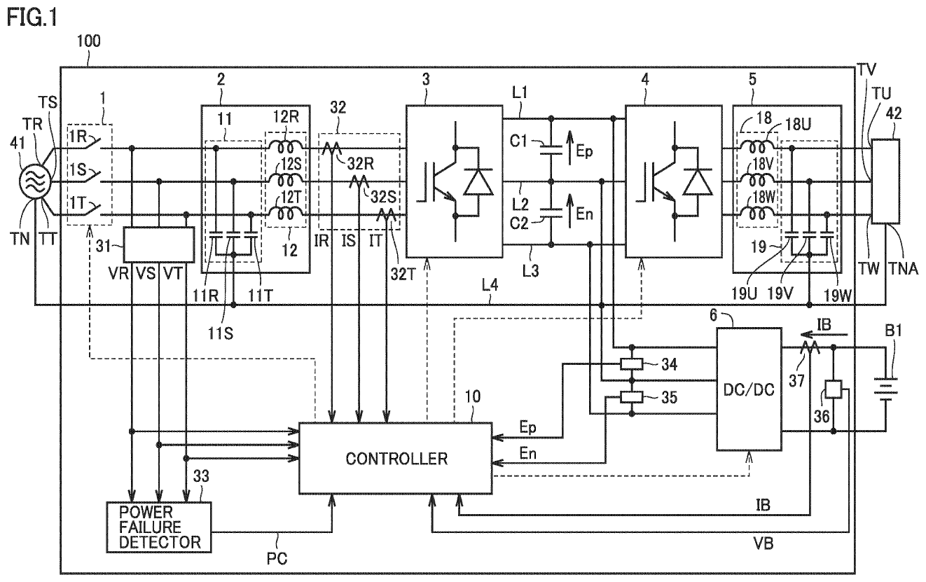

FIG. 1 is a block diagram showing an overall configuration of an uninterruptible power supply device to which a power conversion device according to the present disclosure is applied.

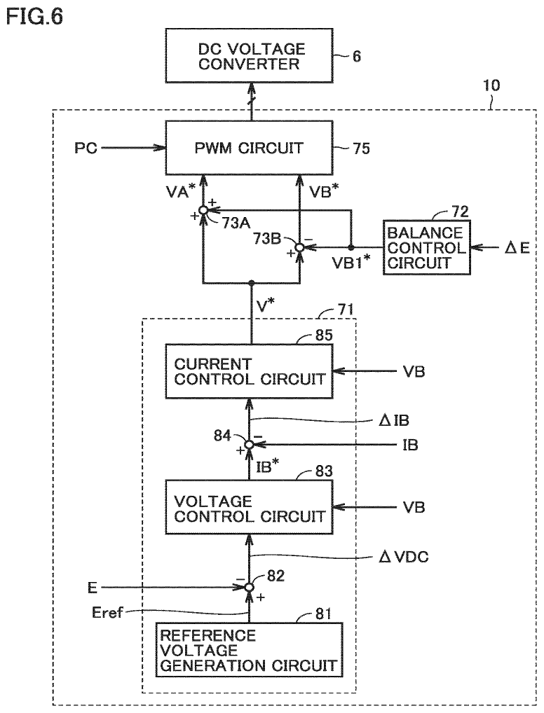

As shown in FIG. 1, an uninterruptible power supply device 100 includes a switch 1, an AC input filter 2, a converter 3, an inverter 4, an AC output filter 5, a DC voltage converter (denoted as “DC/DC” in the FIG. 6, a controller 10, DC lines L1 to L3, a neutral point line L4, capacitors C1, C2, voltage detectors 31, 34, 35, 36, current detectors 31, 34, 35, 36, current detectors 32, 37, and a power failure detector 33.

Switch 1 includes switches 1R, 1S, IT. First terminals of switches 1R, 1S, IT are connected respectively to an R-phase terminal TR, an S-phase terminal TS, and a T-phase terminal TT of a three-phase four-line commercial AC power supply 41, and receive an R-phase voltage VR, an S-phase voltage VS, and a T-phase voltage VT supplied from commercial AC power supply 41, respectively. A neutral point terminal TN of commercial AC power supply 41 is connected to one end of neutral point line L4.

Switches 1R, 1S, 1T are controlled by controller 10, and are turned on when three-phase AC power is normally supplied from commercial AC power supply 41 (during normal operation of commercial AC power supply 41) and turned off when the supply of three-phase AC power from commercial AC power supply 41 is stopped (during a power failure of commercial AC power supply 41). Switches 1R, 1S, 1T are turned off during a power failure of commercial AC power supply 41 to electrically disconnect commercial AC power supply 41 and AC input filter 2 from each other.

AC input filter 2 is a three-phase LC filter circuit composed of a capacitor 11 (capacitors 11R, 11S, 11T) and a reactor 12 (reactors 12R, 12S, 12T). Capacitors 11R, 11S, 11T have positive electrodes connected to second terminals of switches 1R, 1S, 1T, respectively, and negative electrodes all connected to neutral point line L4. Reactors 12R, 12S, 12T have first terminals connected respectively to the second terminals of switches 1R, 1S, 1T, and second terminals connected respectively to three input nodes of converter 3. Reactor 12 corresponds to an embodiment of the “first reactor”.

AC input filter 2 is a low-pass filter, which allows AC power of commercial frequency supplied from commercial AC power supply 41 to pass through to converter 3 and prevents signals of switching frequency generated in converter 3 from passing through to the commercial AC power supply 41 side.

DC lines L1 to L3 have first ends connected to three output nodes of converter 3 and second ends connected to the three input nodes of inverter 4. DC line L2 is connected to neutral point line L4. DC lines L1 to L3 are connected to three high-voltage-side nodes of DC voltage converter 6. DC lines L1 to L3 are caused to have a positive voltage, a neutral point voltage, and a negative voltage, respectively, by converter 3 and DC voltage converter 6.

Capacitor C1 is connected between DC lines L1 and L2, and smooths and stabilizes a DC voltage Ep between DC lines L1 and L2. Capacitor C2 is connected between DC lines L2 and L3, and smooths and stabilizes a DC voltage En between DC lines L2 and L3.

Converter 3 is controlled by controller 10 and, during normal operation of commercial AC power supply 41, converts three-phase AC power supplied from commercial AC power supply 41 through AC input filter 2 into DC power and supplies the DC power to inverter 4 and DC voltage converter 6 through DC lines L1 to L3. Converter 3 corresponds to an embodiment of the “power converter”.

At that time, controller 10 controls converter 3 such that a voltage E=Ep+En, which is the sum of DC voltages Ep and En, becomes equal to a reference DC voltage Eref and a voltage ΔE=Ep−En, which is the difference between DC voltages Ep, En, becomes equal to zero.

During a power failure of commercial AC power supply 41, controller 10 stops an operation of converter 3 when a DC voltage ΔE is less than a threshold voltage ETH, and controls converter 3 to reduce DC voltage ΔE when DC voltage ΔE is greater than threshold voltage ETH.

Inverter 4 is controlled by controller 10 and converts DC power from converter 3 and DC voltage converter 6 into three-phase AC power of commercial frequency. Inverter 4 corresponds to an embodiment of the “power converter”. As will be described later, each of converter 3, inverter 4, and DC voltage converter 6 includes a multilevel circuit. The three-phase AC power generated by inverter 4 is supplied to a load 42 through AC output filter 5.

AC output filter 5 is a three-phase LC filter circuit composed of a reactor 18 (reactors 18U, 18V, 18W) and a capacitor 19 (capacitors 19U, 19V, 19W). Reactors 18U, 18V, 18W have first terminals connected respectively to the three output nodes of inverter 4, and second terminals connected respectively to a U-phase terminal TU, a V-phase terminal TV, and a W-phase terminal TW of three-phase four-line load 42. Reactor 18 corresponds to an example of the “first reactor”.

Capacitors 19U, 19V, 19W have positive electrodes connected to the second terminals of reactors 18U, 18V, 18W and negative electrodes all connected to neutral point line L4. AC output filter 5 is a low-pass filter, which allows the three-phase AC power of commercial frequency generated by inverter 4 to pass through to load 42 and prevents signals of switching frequency generated by inverter 4 from passing through to load 42. Load 42 has a neutral point terminal TNA connected to neutral point line L4. Load 42 is driven by the three-phase AC power supplied from uninterruptible power supply device 100.

A battery B1 (power storage device) is connected between the two low-voltage-side nodes of DC voltage converter 6. DC voltage converter 6 is controlled by controller 10, and during normal operation of commercial AC power supply 41 stores the DC power generated by converter 3 in battery B1. At that time, controller 10 controls DC voltage converter 6 such that a voltage VB between the terminals of battery B1 becomes equal to a reference battery voltage VBr.

DC voltage converter 6 is controlled by controller 10 to supply DC power from battery B1 to inverter 4 through DC lines L1 to L3 during a power failure of commercial AC power supply 41. At that time, controller 10 controls DC voltage converter 6 such that voltage E=Ep+En, which is the sum of DC voltages Ep, En, becomes equal to reference DC voltage Eref, and voltage ΔE=Ep−En, which is the difference between DC voltages Ep, En, becomes equal to 0 V.

A capacitor (e.g., an electric double layer capacitor) may be connected to DC voltage converter 6 instead of battery B1. In Embodiment 1, battery B1 is installed outside uninterruptible power supply device 100, but battery B1 may be built in uninterruptible power supply device 100.

Further, a DC power supply (e.g., a fuel cell) may be connected instead of battery B1. In this case, the operation of DC voltage converter 6 is stopped during normal operation of commercial AC power supply 41.

Voltage detector 31 detects instantaneous values of AC voltages VR, VS, VT at the second terminals of switches 1R, 1S, 1T and outputs three-phase voltage signals indicating three-phase AC voltages VR, VS, VT to controller 10 and power failure detector 33. Current detector 32 detects instantaneous values of AC currents IR, IS, IT flowing into the three input nodes of converter 3 and outputs a three-phase current signal indicating three-phase AC currents IR, IS, IT to controller 10.

Power failure detector 33 determines whether a power failure of commercial AC power supply 41 has occurred based on the three-phase voltage signal from voltage detector 31, and outputs a power failure signal PC indicating a result of the determination. During normal operation of commercial AC power supply 41, power failure signal PC is at an “L” level, which is the deactivation level. During a power failure of commercial AC power supply 41, power failure signal PC is at an “H” level, which is the activation level. Power failure signal PC is provided to controller 10.

Voltage detector 34 detects voltage Ep between the terminals of capacitor C1 and outputs a signal indicating the detected voltage Ep to controller 10. Voltage detector 35 detects voltage En between the terminals of capacitor C2 and outputs a signal indicating the detected voltage En to controller 10. Voltage detector 36 detects voltage VB between the terminals of battery B1 and outputs a signal indicating the detected voltage VB to controller 10. Current detector 37 detects a current IB output from battery B1 and outputs a signal indicating the detected current IB to controller 10.

Controller 10 controls the operations of switch 1, converter 3, inverter 4, and DC voltage converter 6. As will be described later in detail, converter 3, inverter 4, and DC voltage converter 6 are composed of semiconductor switching elements. In Embodiment 1, insulated gate bipolar transistors (IGBTs) are used as the semiconductor switching elements. Any semiconductor element such as a metal oxide semiconductor field effect transistor (MOSFET) can be used as the semiconductor switching element. In addition, pulse width modulation (PWM) control is applied as the control method for a semiconductor switching element in Embodiment 1.

Controller 10 receives the three-phase voltage signal from voltage detector 31, the three-phase current signal from current detector 32, the signal indicating voltage Ep detected by voltage detector 34, the signal indicating voltage En detected by voltage detector 35, power failure signal PC from power failure detector 33, the signal indicating voltage VB detected by voltage detector 36, the signal indicating current IB detected by current detector 37, and any other signal and executes PWM control.

Controller 10 is implemented by, for example, a microcomputer that executes a predetermined program.

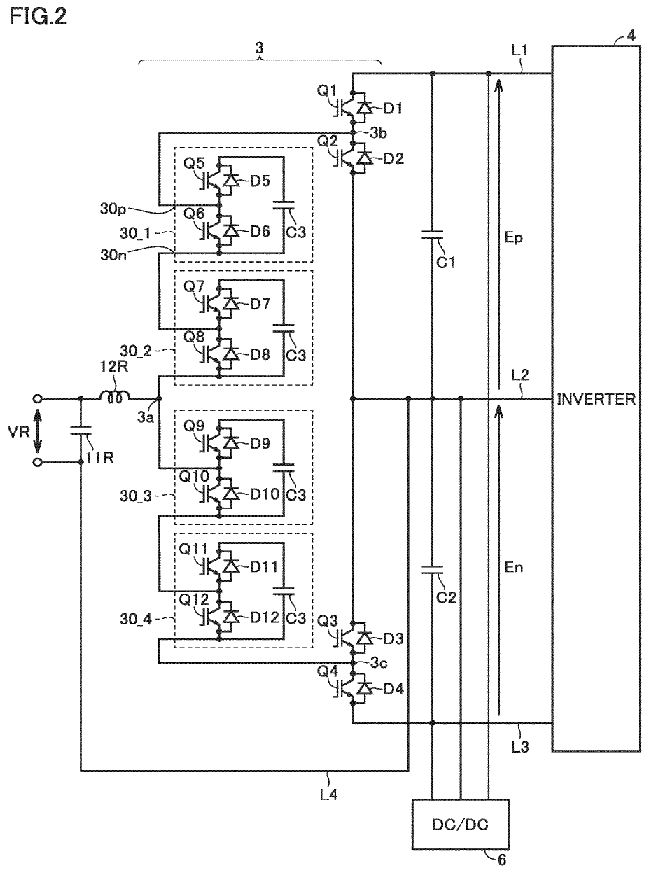

FIG. 2 is a circuit diagram showing an example configuration of converter 3 and its peripherals shown in FIG. 1. In FIG. 2, for simplification of the drawing and description, only the circuit part corresponding to one phase (e.g., R phase) of three phases (R phase, S phase, T phase) is shown.

As shown in FIG. 2, converter 3 is composed of IGBTs Q1 to Q4, diodes D1 to D4, and a plurality of unit converters 30_1 to 30_4.

IGBTs Q1 to Q4 correspond to an embodiment of the “first to fourth switching elements”. IGBTs Q1, Q2 are connected in series between DC line L1 and DC line L2. IGBTs Q3, Q4 are connected in series between DC line L2 and DC line L3.

Diodes D1 to D4 are connected in anti-parallel to IGBTs Q1 to Q4, respectively. Diodes D1 to D4 are provided to flow a return current (freewheeling current) when the corresponding IGBT is turned off. When the switching element is a MOSFET, diodes D1 to D4 may be composed of parasitic diodes (body diodes).

The plurality of unit converters 30_1 to 30_4 (hereinafter, which may be comprehensively referred to as “unit converter 30”) are connected in series between a point of connection 3b between IGBTs Q1, Q2 and a point of connection 3c between IGBTs Q3, Q4. In FIG. 2, unit converters 30_1, 30_2 are connected in series between point of connection 3b and input node 3a (AC terminal) of converter 3, and unit converters 30_3, 30_4 are connected in series between input node 3a and point of connection 3c. Input node 3a is connected to the second terminal of reactor 12R.

Each unit converter 30 has a main circuit of half-bridge type. For example, when description will be representatively given to unit converter 30_1, the main circuit includes series-connected IGBTs Q5, Q6, diodes D5, D6, and a capacitor C3 serving as an energy storage element. Diodes D5, D6 are connected in anti-parallel to IGBTs Q5, Q6, respectively. Capacitor C3 is connected in parallel to the series circuit of IGBTs Q5, Q6 and smooths the DC voltage.

A point of connection between IGBTs Q5, Q6 is connected to an input/output terminal 30p on the positive side, and a point of connection between IGBT Q6 and capacitor C3 is connected to an input/output terminal 30n on the negative side. The main circuit is configured to output the voltage of capacitor C3 or zero voltage to between input/output terminals 30p, 30n by controlling on/off of IGBTs Q5, Q6.

FIG. 2 illustrates an example in which the main circuit of unit converter 30 is composed of a half-bridge circuit, but the present disclosure is not limited thereto. For example, the main circuit may be composed of a full bridge circuit.

IGBTs Q1, Q2 and unit converters 30_1, 30_2 constitute the “upper arm”. DC voltage Ep is equally divided by the voltages of capacitors C3 of unit converters 30_1, 30_2. For a DC voltage Ep=E/2, when the voltage of capacitor C3 of each unit converter 30 is VC, VC=E/4.

IGBTs Q3, Q4 and unit converters 30_3, 30_4 constitute the “lower arm”. DC voltage En is equally divided by the voltages of capacitors C3 of unit converters 30_3, 30_4. For DC voltage En=E/2, voltage VC of capacitor C3 of each unit converter 30 is E/4.

In converter 3, series-connected unit converters 30_1 to 30_4 constitute the “first multilevel circuit”. The first multilevel circuit is configured to mutually convert the positive voltage received by point of connection 3b and the negative voltage received by point of connection 3c, and the AC voltage having five voltage values which is received by input node 3a. The first multilevel circuit will be described later in detail.

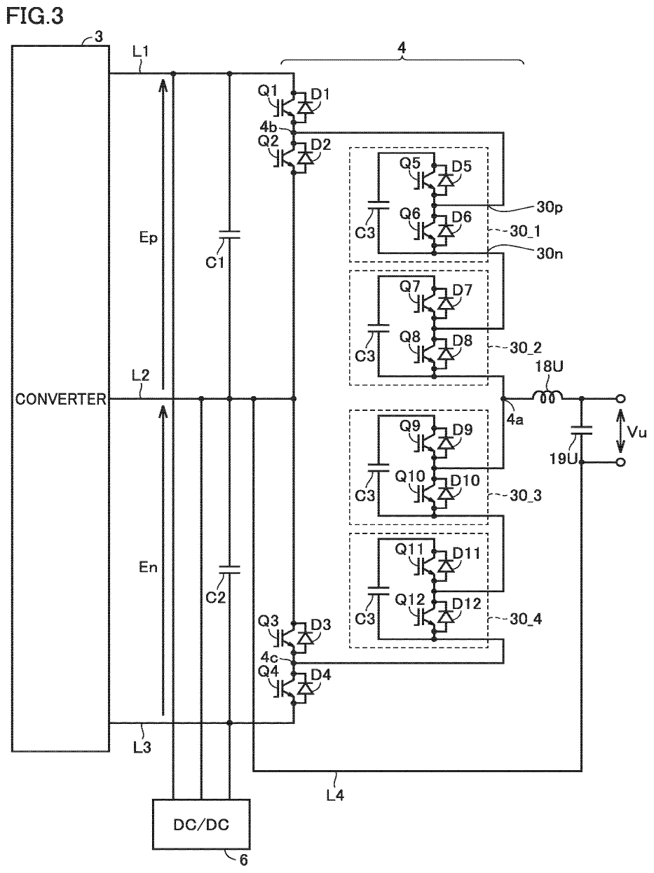

FIG. 3 is a circuit diagram showing an example configuration of inverter 4 and its peripherals shown in FIG. 1. In FIG. 3, only the circuit part corresponding to one phase (e.g., U phase) of three phases (U phase, V phase, W phase) is shown for simplification of the drawing and description.

As shown in FIG. 3, the basic configuration of inverter 4 is the same as converter 3 shown in FIG. 2. In other words, inverter 4 is composed of IGBTs Q1 to Q4, diodes D1 to D4, and unit converters 30_1 to 30_4.

Unit converters 30_1 to 30_4 are connected in series between a point of connection 4b between IGBTs Q1, Q2 and a point of connection 4c between IGBTs Q3, Q4. In FIG. 3, unit converters 30_1, 30_2 are connected in series between point of connection 4b and an output node 4a (AC terminal) of inverter 4, and unit converters 30_3, 30_4 are connected in series between output node 4a and point of connection 4c. Output node 4a is connected to the first terminal of reactor 18U.

In inverter 4, series-connected unit converters 30_1 to 30_4 constitute the “first multilevel circuit”. The first multilevel circuit is configured to mutually convert the positive voltage received by point of connection 4b and the negative voltage received by point of connection 4c, and the AC voltage having five voltage values which is received by output node 4a.

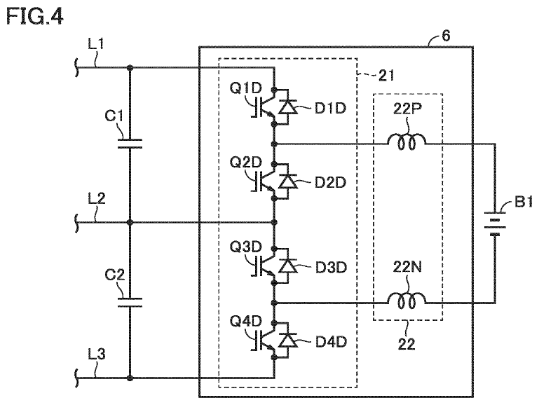

FIG. 4 is a circuit diagram showing an example configuration of DC voltage converter 6 shown in FIG. 1. As shown in FIG. 4, DC voltage converter 6 includes a semiconductor switch 21 and a reactor 22. Semiconductor switch 21 is configured as a three-level circuit and includes IGBT elements Q1D to Q4D connected in series between DC lines L1, L3 and diodes D1D to D4D connected in anti-parallel to IGBT elements Q1D to Q4D, respectively. Semiconductor switch 21 constitutes the “second multilevel circuit”. IGBTs Q1D, Q2D correspond to an embodiment of the “seventh and eighth switching elements”, and IGBTs Q3D, Q4D correspond to an embodiment of the “ninth and tenth switching elements”.

Reactor 22 includes reactors 22P, 22N. Reactor 22P is connected between a point of connection between IGBT elements Q1D, Q2D and the positive electrode of battery B1. Reactor 22N is connected between a point of connection between IGBT elements Q3D, Q4D and the negative electrode of battery B1. Reactor 22P corresponds to an embodiment of the “second reactor”, and reactor 22N corresponds to an embodiment of the “third reactor”.

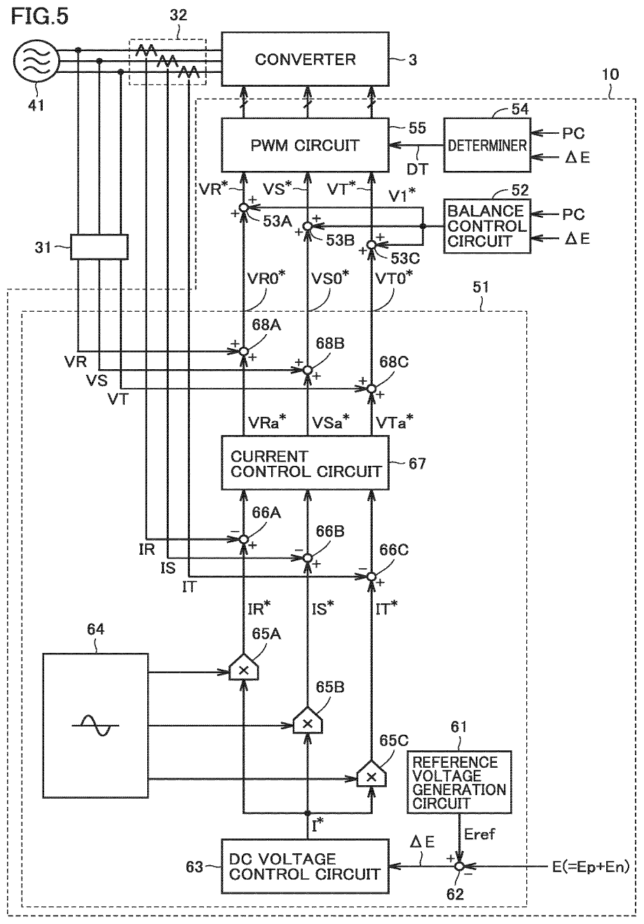

FIG. 5 is a functional block diagram showing an example configuration for controlling converter 3. As shown in FIG. 5, controller 10 includes a voltage command generation circuit 51, a balance control circuit 52, adders 53A to 53C, a determiner 54, and a PWM circuit 55. Voltage command generation circuit 51 includes a reference voltage generation circuit 61, subtractors 62, 66A to 66C, a DC voltage control circuit 63, a sine wave generation circuit 64, multipliers 65A to 65C, a current control circuit 67, and adders 68A to 68C.

Reference voltage generation circuit 61 generates reference DC voltage Eref. Subtractor 62 calculates a voltage ΔE=Eref−E, which is the difference between reference DC voltage Eref and DC voltage E (=Ep+En). DC voltage control circuit 63 calculates a current command value I* for controlling the current flowing on the input side of converter 3 such that voltage ΔE becomes equal to zero. DC voltage control circuit 63 calculates current command value I* by, for example, proportional operation or proportional-integral operation of ΔE.

Sine wave generation circuit 64 outputs a sine wave signal in phase with R-phase voltage VR of commercial AC power supply 41, a sine wave signal in phase with S-phase voltage VS of commercial AC power supply 41, and a sine wave signal in phase with T-phase voltage VT of commercial AC power supply 41. Sine wave generation circuit 64 outputs three-phase sine wave signals also during a power failure of commercial AC power supply 41. The three sine wave signals are respectively input to multipliers 65A to 65C and multiplied by current command value I*. This generates current command values IR*, IS*, IT*, which are in phase with three-phase AC voltages VR, VS, VT of commercial AC power supply 41.

Subtractor 66A calculates the difference between current command value IR* and R-phase current IR detected by current detector 32. Subtractor 66B calculates the difference between current command value IS* and S-phase current IS detected by current detector 32. Subtractor 66C calculates the difference between current command value IT* and T-phase current IT detected by current detector 32.

Current control circuit 67 generates voltage command values VRa*, VSa*, VTa* as the voltages to be applied to reactor 12 such that the difference between current command value IR* and R-phase current IR, the difference between current command value IS* and S-phase current IS, and the difference between current command value IT* and T-phase current IT all become equal to zero. Current control circuit 67 generates the voltage command values by, for example, amplifying the difference between the current command value and the current value detected by current detector 32 according to proportional control or proportional-integral control.

Adder 68A generates a voltage command value VR0* by adding voltage command value VRa* and R-phase voltage VR detected by voltage detector 31. Adder 68B generates a voltage command value VS0* by adding voltage command value VSa* and S-phase voltage VS detected by voltage detector 31. Adder 68C generates a voltage command value VT0* by adding voltage command value VTa* and T-phase voltage VT detected by voltage detector 31.

Thus, voltage command generation circuit 51 receives three-phase AC voltages VR, VS, VT detected by voltage detector 31, three-phase AC currents IR, IS, IT detected by current detector 32, and DC voltage E (=Ep+En), and generates voltage command values VR0*, VS0*, VT0* corresponding to the R phase, the S phase, and the T phase, respectively.

Balance control circuit 52 generates a voltage command value V1* based on power failure signal PC from power failure detector 33 (FIG. 1) and DC voltage ΔE=Ep−En. For example, balance control circuit 52 generates voltage command value V1* by proportional operation or proportional-integral operation of ΔE.

When power failure signal PC is at the “L” level that is the deactivation level and ΔE=Ep−En>0, voltage command value V1* is generated such that the charge time of capacitor C1 is shorter than that of capacitor C2. When power failure signal PC is at the “L” level that is the deactivation level and ΔE=Ep−En<0, voltage command value V1* is generated such that the charge time of capacitor C1 is longer than the discharge time of capacitor C2.

When power failure signal PC is at the “H” level that is the activation level and ΔE=Ep−En>0, voltage command value V1* is generated such that the discharge time of capacitor C1 is longer than the discharge time of capacitor C2. When power failure signal PC is at the “H” level that is the activation level and ΔE=Ep−En<0, voltage command value V1* is generated such that the discharge time of capacitor C1 is shorter than the discharge time of capacitor C2.

Adder 53A adds voltage command values VR0*, V1* to generate a voltage command value VR*. Adder 53B adds voltage command values VS0*, V1* to generate a voltage command value VS*. Adder 53C adds voltage command values VT0*, V1* to generate a voltage command value VT*.

Determiner 54 generates a signal DT based on power failure signal PC from power failure detector 33 (FIG. 1) and DC voltage ΔE. When power failure signal PC is at the “L” level that is the deactivation level (during normal operation of commercial AC power supply 41), signal DT is set to the “H” level that is the activation level.

When power failure signal PC is at the “H” level that is the activation level (during a power failure of commercial AC power supply 41), and when DC voltage ΔE is smaller than threshold voltage ETH, signal DT is set to the “L” level that is the deactivation level. When power failure signal PC is at the “H” level that is the activation level (during a power failure of commercial AC power supply 41), and when DC voltage ΔE is greater than threshold voltage ETH, signal DT is set to the “H” level that is the activation level.

PWM circuit 55 is activated when signal DT is at the “H” level that is the activation level, and based on voltage command values VR*, VS*, VT*, outputs a signal for causing three-phase AC voltages VR, VS, VT detected by voltage detector 31 to be equal to voltage command values VR*, VS*, VT*, respectively. This signal is a gate signal for driving IGBTs Q1 to Q4 and unit converters 30_1 to 30_4 included in each phase arm of converter 3 (FIG. 2).

PWM circuit 55 is deactivated when signal DT is at the “L” level that is the deactivation level to turn off IGBTs Q1 to Q4 and unit converters 30_1 to 30_4 included in each phase arm of converter 3. This stops the operation of converter 3.

As converter 3 is controlled by controller 10 having the above configuration, three-phase AC currents IR, IS, IT can become in phase with three-phase AC voltages VR, VS, VT of commercial AC power supply 41 and turn into sinusoidal currents, thus setting the power factor to nearly one.

FIG. 6 is a functional block diagram showing an example configuration for controlling DC voltage converter 6. As shown in FIG. 6, controller 10 includes a voltage command generation circuit 71, a balance control circuit 72, an adder 73A, a subtractor 73B, and a PWM circuit 75. Voltage command generation circuit 71 includes a reference voltage generation circuit 81, subtractors 82, 84, a voltage control circuit 83, and a current control circuit 85.

Reference voltage generation circuit 81 generates reference DC voltage Eref. Subtractor 82 calculates voltage ΔE, which is the difference between reference DC voltage Eref and DC voltage E (=Ep+En). Voltage control circuit 83 calculates a current command value IB* of a level corresponding to voltage ΔE based on voltage VB between the terminals of battery B1 detected by voltage detector 36 (FIG. 1). Voltage control circuit 83 calculates current command value IB* by, for example, proportional operation or proportional-integral operation of ΔE. Subtractor 84 determines a deviation ΔIB=IB*−IB between current command value IB* generated by voltage control circuit 83 and current value IB of battery B1 which is detected by current detector 37 (FIG. 1). Current control circuit 85 generates voltage command value V* based on deviation ΔIB between current command value IB* and current value IB.

Thus, voltage command generation circuit 71 receives battery voltage VB detected by voltage detector 36, battery current IB detected by current detector 37, and DC voltage E, and generates voltage command value V* for controlling voltages Ep, En between the terminals of capacitors C1 and C2 to a predetermined voltage.

Balance control circuit 72 receives DC voltage ΔE=Ep−En and generates a voltage command value VB1*. For example, balance control circuit 72 generates voltage command value VB1* by proportional operation or proportional-integral operation of DC voltage ΔE. For example, when ΔE>0, balance control circuit 72 sets voltage command value VB1* to a negative value. Contrastingly, when ΔE<0, balance control circuit 72 sets voltage command value VB1* to a positive value.

Adder 73A adds voltage command values V*, VB1* to generate a voltage command value VA*. Subtractor 73B subtracts voltage command value VB1* from voltage command value V* to generate a voltage command value VB*. Voltage command values VA*, VB* are command values for controlling the voltages of the upper arm and the lower arm of semiconductor switch 21, respectively, and are command values for voltage Ep, En to set difference ΔE between voltages Ep, En to zero. Balance control circuit 72, adder 73A, and subtractor 73B constitute a command value generation circuit that generates voltage command values VA*, VB* for controlling voltages Ep, En, respectively, based on DC voltage ΔE and voltage command value V* such that DC voltage ΔE=Ep−En becomes equal to zero.

When power failure signal PC is at the “H” level that is the activation level (during a power failure of commercial AC power supply 41), PWM circuit 75 is activated and outputs a signal for driving IGBTs Q1D to Q4D included in semiconductor switch 21 based on voltage command values VA*, VB*. DC voltage converter 6 is controlled by the signal from PWM circuit 75 and supplies DC power from battery B1 to inverter 4.

When power failure signal PC is at the “L” level that is the deactivation level (during normal operation of commercial AC power supply 41), PWM circuit 75 is deactivated and does not perform PWM control of DC voltage converter 6. During normal operation of commercial AC power supply 41, DC voltage converter 6 stores DC power in battery B1.

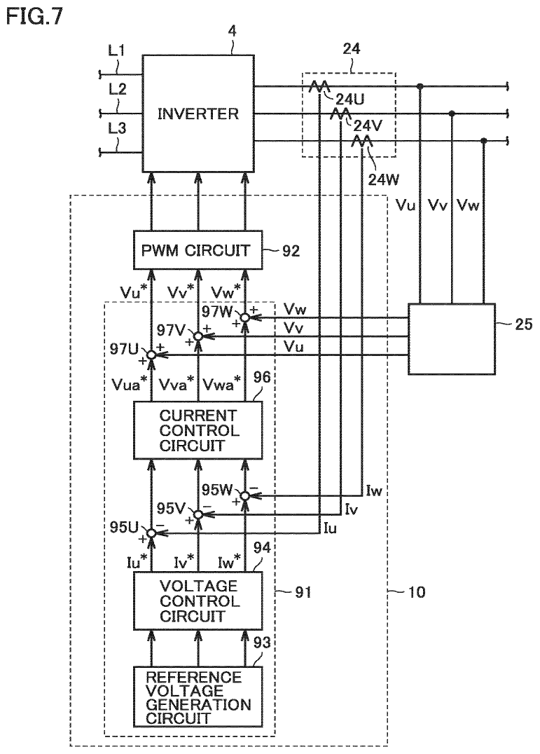

FIG. 7 is a functional block diagram showing an example configuration for controlling inverter 4. As shown in FIG. 7, controller 10 includes a voltage command generation circuit 91 and a PWM circuit 92. Voltage command generation circuit 91 includes a reference voltage generation circuit 93, a voltage control circuit 94, subtractors 95U, 95V, 95W, a current control circuit 96, and adders 97U, 97V, 97W.

Reference voltage generation circuit 93 generates a voltage command value for each of the U phase, the V phase, and the W phase. The signal representing the voltage command value is a sine wave signal. The frequency of the sine wave corresponds to the frequency of the AC voltage.

Voltage control circuit 94 generates current command values Iu*, Iv*, Iw* based on the voltage command values (U phase, V phase, W phase) from reference voltage generation circuit 93. Current command values Iu*, Iv*, Iw* are associated with the U phase, the V phase, and the W phase, respectively.

Subtractor 95U calculates the difference between current command value Iu* and a U-phase current Iu detected by current detector 24U. Subtractor 95V calculates the difference between current command value Iv* and a V-phase current value Iv detected by current detector 24V. Subtractor 95W calculates the difference between current command value Iw* and a W-phase current value Iw detected by current detector 24W.

Current control circuit 96 generates voltage command values Vua*, Vva*, Vwa* as the voltages to be applied to reactor 18 such that the difference between current command value Iu* and U-phase current Iu, the difference between current command value Iv* and V-phase current Iv, and the difference between current command value Iw* and W-phase current Iw all become equal to zero. Current control circuit 96 generates the voltage command value by, for example, amplifying the difference between the current command value and the current value detected by current detector 24 according to proportional control or proportional-integral control.

Adder 97U generates a voltage command value Vu* by adding voltage command value Vua* and a U-phase voltage Vu detected by voltage detector 25. Adder 97V generates a voltage command value Vv* by adding voltage command value Vva* and a V-phase voltage Vv detected by voltage detector 25. Adder 97W generates a voltage command value Vw* by adding voltage command value Vwa* and a W-phase voltage Vw detected by voltage detector 25.

Thus, voltage command generation circuit 91 receives three-phase AC voltages Vu, Vv, Vw detected by voltage detector 25 and three-phase AC currents Iu, Iv, Iw detected by current detector 24, and generates voltage command values Vu*, Vv*, Vw* corresponding to the U phase, the V phase, and the W phase, respectively.

Based on voltage command values Vu*, Vv*, Vw*, PWM circuit 92 outputs a signal for causing three-phase AC voltages Vu, Vv, Vw detected by voltage detector 25 to become equal to voltage command values Vu*, Vv*, Vw*, respectively. The signal is a gate signal for driving IGBTs Q1 to Q4 and unit converters 30_1 to 30_4 included in each phase arm of inverter 4 (FIG. 3).

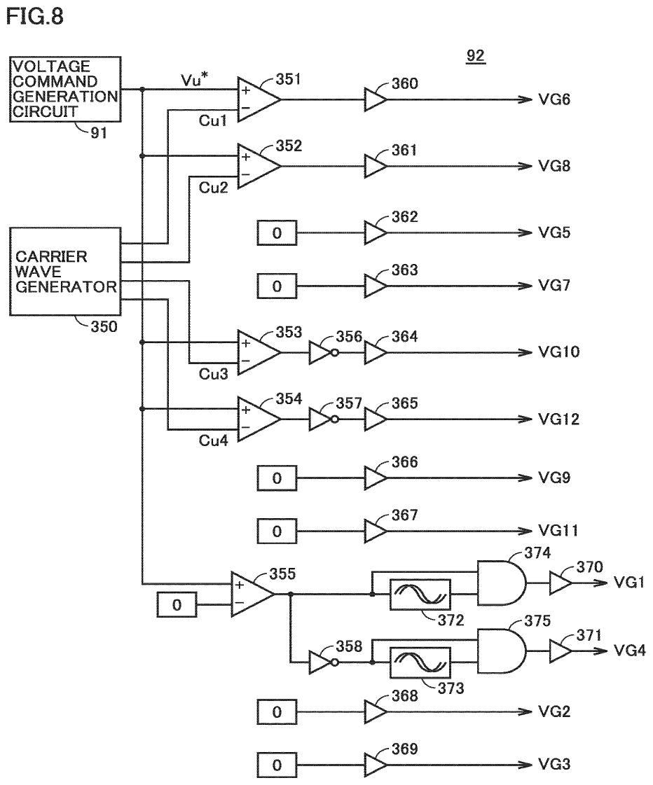

The configuration of PWM circuit 92 is the same as the configuration of PWM circuit 55 shown in FIG. 5. The configuration of PWM circuit 92 will be representatively described below. FIG. 8 is a functional block diagram of PWM circuit 92 shown in FIG. 7. In FIG. 8, only the functional block of the part corresponding to one phase (e.g., U phase) of three phases (U phase, V phase, W phase) is shown.

As shown in FIG. 8, PWM circuit 92 includes a carrier wave generator 350, comparators 351 to 355, negative (NOT) circuits 356 to 358, buffers 360 to 371, delay circuits 372, 373, and logic product (AND) circuits 374, 374.

Carrier wave generator 350, for example, generates four carrier waves Cu1 to Cu4 according to a function set in advance. The number of carrier waves generated by carrier wave generator 350 is equal to the number of unit converters 30 constituting the first multilevel circuit.

Carrier waves Cu1 to Cu4 are triangular waves having the same phase and the same frequency. Carrier waves Cu1, Cu2 are signals that vary on the positive side, and carrier waves Cu3, Cu4 are signals that vary on the negative side. The carrier waves may be saw waves. The frequencies of carrier waves Cu1 to Cu4 are higher than the frequency of voltage command value Vu*.

Comparator 351 compares the level of voltage command value Vu* from voltage command generation circuit 91 with the level of carrier wave Cu1 from carrier wave generator 350, and outputs a PWM signal indicating a result of the comparison. The frequency of the PWM signal has the same value as that of the frequency of the carrier wave. Buffer 360 generates a gate signal VG6 for turning on/off IGBT Q6 based on the PWM signal.

Comparator 352 compares the level of voltage command value Vu* from voltage command generation circuit 91 with the level of carrier wave Cu2 from carrier wave generator 350, and outputs a PWM signal indicating a result of the comparison. Buffer 361 generates a gate signal VG8 for turning on/off IGBT Q8 based on the PWM signal.

Comparator 353 compares the level of voltage command value Vu* from voltage command generation circuit 91 with the level of carrier wave Cu4 from carrier wave generator 350, and outputs a PWM signal indicating a result of the comparison. NOT circuit 356 inverts the PWM signal from comparator 353 and provides the PWM signal to buffer 364. Buffer 364 generates a gate signal VG10 for turning on/off IGBT Q10 based on the PWM signal.

Comparator 354 compares the level of voltage command value Vu* from voltage command generation circuit 91 with the level of carrier wave Cu3 from carrier wave generator 350, and outputs a PWM signal indicating a result of the comparison. NOT circuit 357 inverts the PWM signal from comparator 354 and provides the PWM signal to buffer 365. Buffer 365 generates a gate signal VG12 for turning on/off IGBT Q12 based on the PWM signal.

Comparator 355 compares the level of voltage command value Vu* from voltage command generation circuit 91 with the level of a signal having the value “0” and generates a PWM signal indicating a result of the comparison. Delay circuit 372 delays the PWM signal by a predetermined time Td. Delay time Td of delay circuit 372 corresponds to the dead time when IGBTs Q1 to Q4 are all turned off. AND circuit 374 generates a gate signal VG1 for turning on/off IGBT Q1 based on the PWM signal from comparator 355 and the PWM signal from delay circuit 372.

NOT circuit 358 inverts the PWM signal from comparator 355 and provides the PWM signal to AND circuit 375 and delay circuit 373. Delay circuit 373 delays the PWM signal by time Td. AND circuit 375 generates a gate signal VG4 for turning on/off IGBT Q4 based on the PWM signal from NOT circuit 358 and the PWM signal from the delay circuit.

Buffer 362 generates a gate signal VG5 for turning on/off IGBT Q5 based on the signal having the value “0”. Buffer 363 generates gate signal VG5 for turning on/off IGBT Q7 based on the signal having the value “0”. Buffer 366 generates a gate signal VG9 for turning on/off IGBT Q9 based on the signal having the value “0”. Buffer 367 generates a gate signal VG11 for turning on/off IGBT Q11 based on the signal having the value “0”. Buffer 368 generates a gate signal VG2 for turning on/off IGBT Q2 based on the signal having the value “0”. Buffer 369 generates a gate signal VG3 for turning on/off IGBT Q3 based on the signal having the value “0”.

When gate signals VG1 to VG12 are set to the “H” level that is the activation level, IGBTs Q1 to Q12 are turned on, respectively. When gate signals VG1 to VG12 are set to the “L” level that is the deactivation level, IGBTs Q1 to Q12 are turned off, respectively.

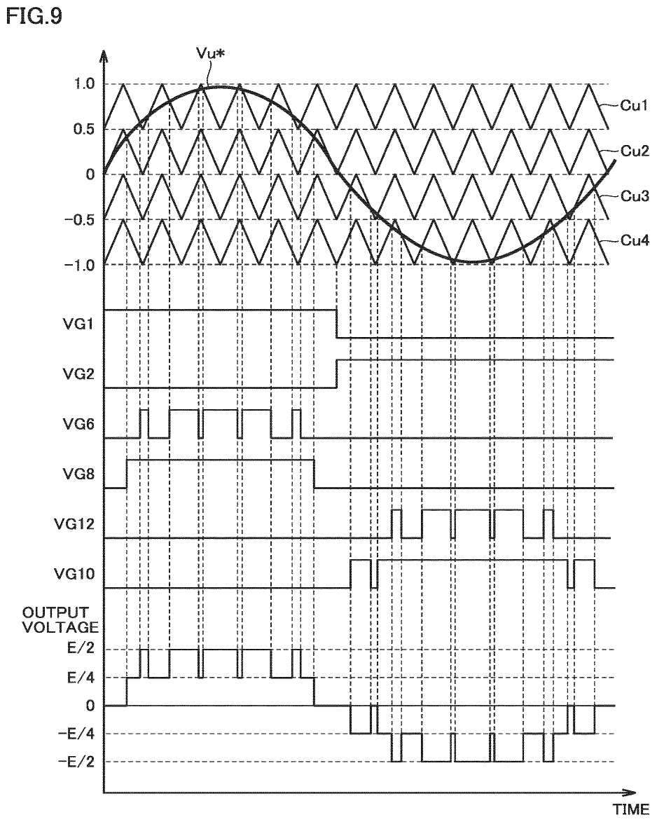

FIG. 9 is a time chart showing waveforms of voltage command value Vu*, carrier waves Cu1 to Cu4, gate signals VG1, VG2, VG6, VG8, VG10, VG12 shown in FIG. 8, and the voltage generated at output node 4a of inverter 4.

As shown in FIG. 9, voltage command value Vu* is represented by a sine wave. When the maximum value of the amplitude of voltage command value Vu* is 1, the peak-to-peak value of each of carrier waves Cu1 to Cu4 is 0.5. Carrier wave Cu1 has a maximum value of 1 and a minimum value of 0.5. Carrier wave Cu2 has a maximum value of 0.5 and a minimum value of 0. Carrier wave Cu3 has a maximum value of 0 and a minimum value of −0.5. Carrier wave Cu4 has a maximum value of −0.5 and a minimum value of −1.0. Carrier waves Cu1 to Cu4 are signals in the same phase, and the phases of carrier waves Cu1 to Cu4 are synchronized with the phase of voltage command value Vu*.

Gate signal VG1 enters the H level when voltage command value Vu* is higher than zero, and gate signal VG1 enters the L level when Vu* is lower than zero. Gate signal VG2 enters the H level when Vu* is lower than zero, and gate signal VG2 enters the L level when Vu* is higher than zero.

When the level of carrier wave Cu1 is higher than that of voltage command value Vu*, gate signal VG6 enters the L level. Conversely, when the level of carrier wave Cu1 is lower than that of voltage command value Vu*, gate signal VG6 enters the “H” level.

When the level of carrier wave Cu2 is higher than that of voltage command value Vu*, gate signal VG8 enters the “L” level. Conversely, when the level of carrier wave Cu2 is lower than that of voltage command value Vu*, gate signal VG8 enters the “H” level.

When the level of carrier wave Cu3 is lower than that of voltage command value Vu*, gate signal VG10 enters the “L” level. Conversely, when the level of carrier wave Cu3 is higher than that of voltage command value Vu*, gate signal VG10 enters the “H” level.

When the level of carrier wave Cu4 is lower than that of voltage command value Vu*, gate signal VG12 enters the “L” level. Conversely, when the level of carrier wave Cu4 is lower than that of voltage command value Vu*, gate signal VG12 enters the “H” level. Although not shown, gate signals VG3 to VG5, VG7, VG9, VG11 are fixed at the L level.

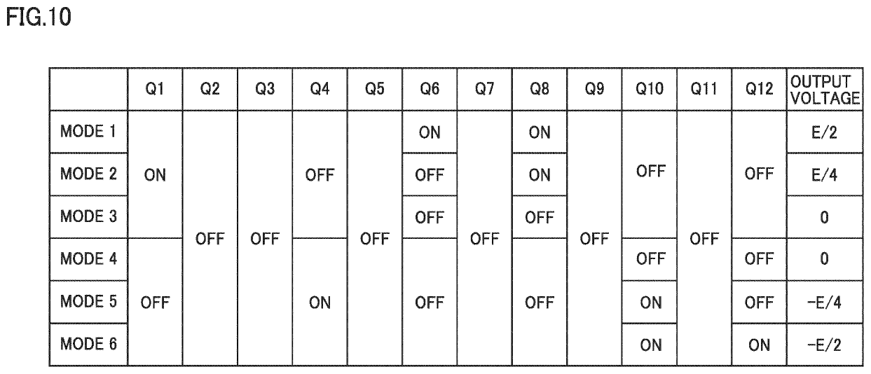

FIG. 10 is a diagram for illustrating the correspondence between the switching pattern of IGBTs Q1 to Q12 and the voltage generated at output node 4a of inverter 4. The switching pattern of IGBTs Q1 to A12 consists of six modes.

As shown in FIG. 10, in the first period in which voltage command value Vu* has positive polarity, IGBT Q1 is fixed in the ON state and IGBTs Q2 to Q5, Q7, Q9 to Q12 are fixed in the OFF state. IGBTs Q6, Q8 are turned on/off according to a result of the comparison between voltage command value Vu* and carrier waves Cu1, Cu2. When Ep=En=E/2 and voltage VC of capacitor C3 of each unit converter 30 is equal to E/4, voltage E/2, E/4, or 0 is generated at output node 4a of inverter 4.

In detail, a mode 1 is the switching pattern when the levels of carrier waves Cu1, Cu2 are lower than the level of voltage command value Vu*. In mode 1, IGBTs Q6, Q8 are turned on and voltage “E/2” is output from output node 4a of inverter 4.

A mode 2 is the switching pattern when the level of carrier wave Cu1 is lower than the level of voltage command value Vu* and the level of carrier wave Cu2 is higher than the level of voltage command value Vu*. In mode 2, IGBT Q6 is turned off and IGBT Q8 is turned on, and voltage “E/4” is output from output node 4a.

A mode 3 is the switching pattern when the levels of carrier waves Cu1, Cu2 are higher than the level of voltage command value Vu*. In mode 3, IGBTs Q6, Q8 are turned off and the voltage “0” is output from output node 4a.

In the second period in which voltage command value Vu* has negative polarity, IGBT Q2 is fixed in the ON state and IGBTs Q1, Q3 to Q5, Q7, Q9 to Q12 are fixed in the OFF state. IGBTs Q10, Q12 are turned on/off according to a result of the comparison between voltage command value Vu* and carrier waves Cu3, Cu4. This generates a voltage 0, −E/4, or −E/2 at output node 4a of inverter 4.

In detail, a mode 4 is the switching pattern when the levels of carrier waves Cu3, Cu4 are lower than the level of voltage command value Vu*. In mode 4, IGBTs Q10, Q12 are turned off and the voltage “0” is output from output node 4a.

A mode 5 is the switching pattern when the level of carrier wave Cu3 is higher than the level of voltage command value Vu* and the level of carrier wave Cu4 is lower than the level of voltage command value Vu*. In mode 5, IGBT Q10 is turned on and IGBT Q12 is turned off, and the voltage “−E/4” is output from output node 4a.

A mode 6 is the switching pattern when the levels of carrier waves Cu3, Cu4 are higher than the level of voltage command value Vu*. In mode 6, IGBTs Q10, Q12 are turned on and the voltage “−E/2” is output from output node 4a.

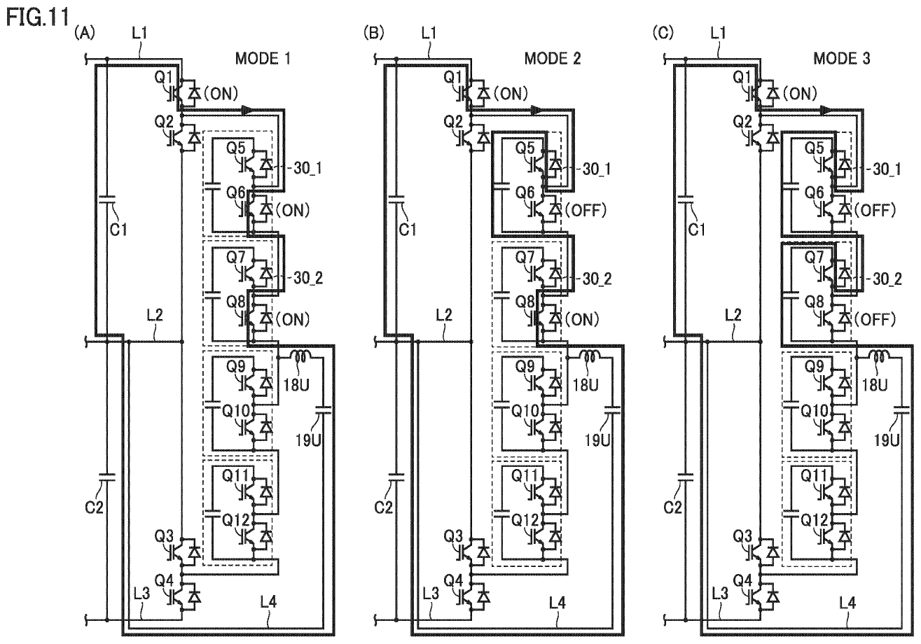

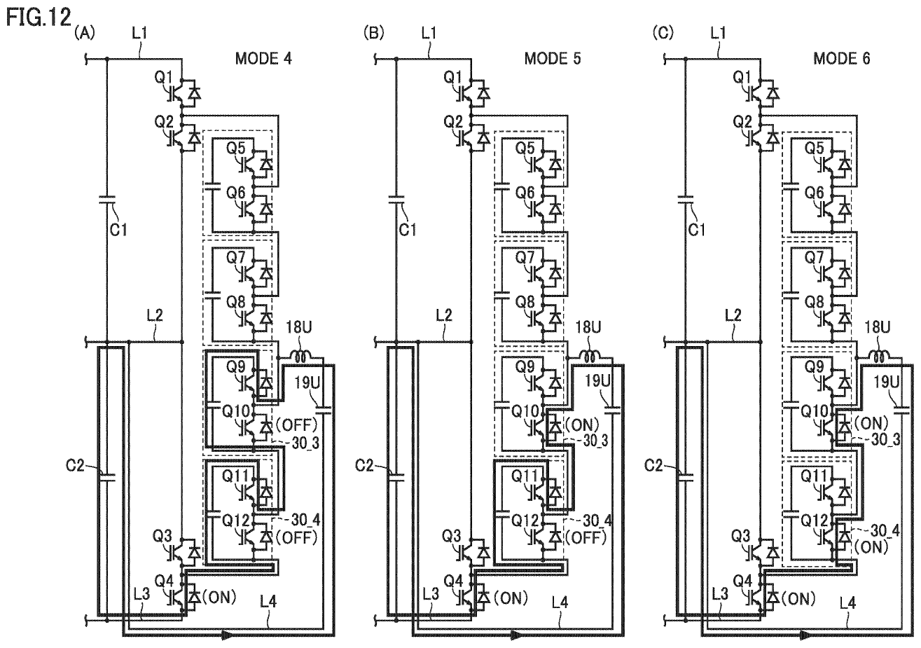

FIGS. 11 and 12 are circuit diagrams showing the operation in each mode shown in FIG. 10. FIG. 11(A) shows mode 1. In mode 1, IGBTs Q1, Q6, Q8 are turned on. A current flows in the direction of the arrow from DC line L1 to DC line L2 through unit converters 30_1, 30_2, reactor 18U, capacitor 19U, and neutral point line L4. Since the voltages output from unit converters 30_1, 30_2 are zero voltage, a positive voltage (=Ep) is output from output node 4a. When Ep=E/2, the voltage “E/2” is output from output node 4a.

FIG. 11(B) shows mode 2. In mode 2, as IGBTs Q1, Q8 are turned on and IGBT Q6 is turned off, a current flows in the direction of the arrow. The voltage output from unit converter 30_1 is voltage VC of capacitor C3, and the voltage output from unit converter 30_2 is zero voltage. Thus, Ep−VC is output from output node 4a. When Ep=E/2 and VC=E/4, the voltage “E/4” is output from output node 4a.

FIG. 11(C) shows mode 3. In mode 3, as IGBTs Q1, Q6, Q8 are turned off, a current flows in the direction of the arrow. The voltages output from unit converters 30_1, 30_2 are voltage VC of capacitor C3, and accordingly, Ep−VC×2 is output from output node 4a. When Ep=E/2 and VC=E/4, the voltage “0” is output from output node 4a. Thus, in the first period, either voltage “E/2”, “E/4”, or “0” is output from output node 4a.

FIG. 12(A) shows mode 4. In mode 4, IGBT Q4 is turned on and IGBTs Q10, Q12 are turned on. A current flows in the direction of the arrow from DC line L2 to DC line L3 through neutral point line L4, capacitor 19U, reactor 18U, unit converters 30_3, 30_4, and IGBT Q4. Since the voltages output from unit converters 30_3, 30_4 are voltage VC of capacitor C3, a negative voltage (=−En)+VC×2 is output from output node 4a. When En=E/2 and VC=E/4, the voltage “0” is output from output node 4a.

FIG. 12(B) shows mode 5. In mode 5, as IGBTs Q4, Q10 are turned on and IGBT Q12 is turned off, a current flows in the direction of the arrow. Since the voltage output from unit converter 30_3 becomes equal to zero voltage and the voltage output from unit converter 30_4 is voltage VC of capacitor C3, −En+VC is output from output node 4a. When En=E/2 and VC=E/4, the voltage “−E/4” is output from output node 4a.

FIG. 12(C) shows mode 6. In mode 6, as IGBTs Q4, Q10, Q12 are turned on, a current flows in the direction of the arrow. Since the voltages output from unit converters 30_1, 30_2 are zero voltage, a negative voltage (=−En) is output from output node 4a. When En=E/2, the voltage “−E/2” is output from output node 4a. Thus, in the second period, either voltage “0”, “−E/4”, or “−E/2” is output from output node 4a.

As described above, the first multilevel circuit is configured to mutually convert the positive voltage (=E/2) received by point of connection 4b between IGBTs Q1, Q2 and the negative voltage (=−E/2) received by point of connection 4c between IGBTs Q3, Q4, and the AC voltage (E/2, E/4, 0, −E/4, −E/2) having five voltage values which is received by output node 4a. Thus, inverter 4 constitutes a 5-level inverter. The waveform of the voltage output from the 5-level inverter is a PWM pulse of +E/4, +E/2, and +E centered on zero. The waveform of the voltage output from the 3-level inverter is a PWM pulse of +E/2, +E centered on zero, whereas the 5-level inverter has a waveform closer to that of a sine wave.

In AC output filter 5, thus, a ripple current flowing through reactor 18 (reactors 18U, 18V, 18W) decreases, and accordingly, the inductance required for causing the waveform of an output voltage to become the waveform of a sine wave can be reduced, miniaturizing reactor 18. By miniaturizing reactor 18, an iron loss of reactor 18 can be reduced.

Further, as the inductance of reactor 18 becomes smaller, an air-core reactor can be applied to reactor 18. The air-core reactor, which does not include an iron core, can eliminate an iron loss. Alternatively, reactor 18 can be configured by connecting a plurality of bent rectangular conductors in combination. In either configuration, the iron loss of reactor 18 can ideally be eliminated.

In the 5-level inverter, the voltage applied to each IGBT is half the voltage of the 3-level inverter, thus reducing approximately by half a switching loss caused in each IGBT.

In the present embodiment, the first multilevel circuit is applied to each of converter 3 and inverter 4. This can reduce switching losses generated in the IGBTs in converter 3 and inverter 4 and reduce iron losses of reactors 12, 18 included in AC input filter 2 and AC output filter 5, respectively. As a result, uninterruptible power supply device 100 can achieve higher efficiency.

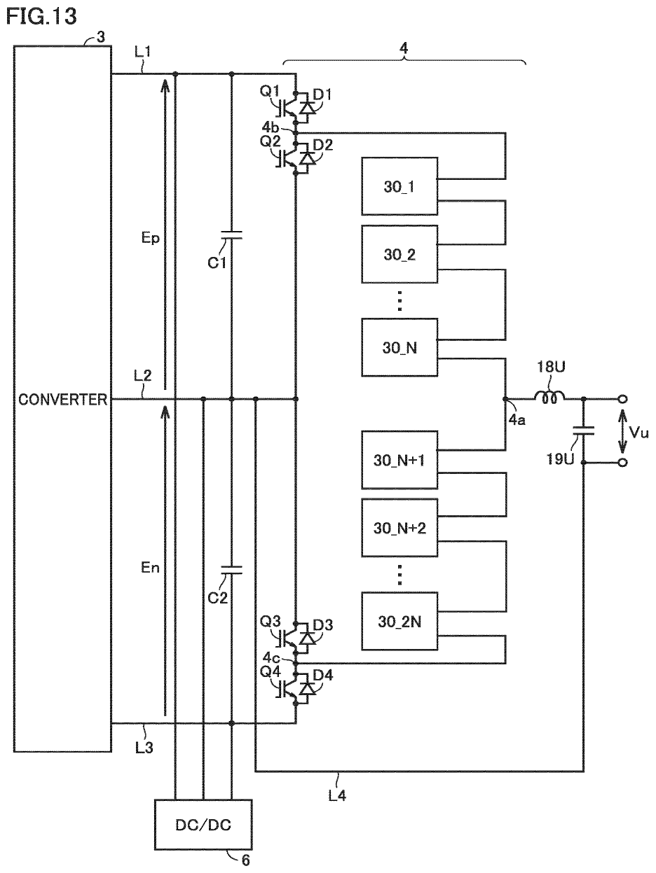

In the first multilevel circuit, the number of levels of output voltage of each of converter 3 and inverter 4 can be further increased by further increasing the number of series-connected unit converters 30. FIG. 13 is a circuit diagram showing an example configuration of inverter 4 and its peripherals. As shown in FIG. 13, the first multilevel circuit is composed of 2N unit converters 30_1 to 30_2N, where N is an integer greater than or equal to 1.

IGBTs Q1, Q2 and unit converters 30_1 to 30_N constitute the upper arm. DC voltage Ep is equally divided by the voltages of capacitors C3 of unit converters 30_1 to 30_N. When DC voltage Ep=E/2, the voltage of capacitor C3 of each unit converter 30 is E/2N. In the first period in which voltage command value Vu* has positive polarity, IGBT Q1 is turned on and each of unit converters 30_1 to 30_N outputs the voltage (=E/2N) of capacitor C3 or zero voltage. Thus, any of a total of (N+1) voltages “0”, “E/2N”, “E/N”, “3E/2N” . . . “E/2” is output from output node 4a.

IGBTs Q3, Q4 and unit converters 30_3, 30_4 constitute the lower arm. DC voltage En is equally divided by the voltages of capacitors C3 of unit converters 30_N+1 to 30_2N. When DC voltage En=E/2, the voltage of capacitor C3 of each unit converter 30 is E/2N. In the second period in which voltage command value Vu* has negative polarity, IGBT Q4 is turned on and each of unit converters 30_N+1 to 30_2N outputs the voltage (=E/2N) of capacitor C3 or zero voltage. Thus, any of a total of (N+1) voltages “0”, “−E/2N”, “−E/N”, “−3E/2N” . . . “−E/2” is output from output node 4a.

Thus, the first multilevel circuit is configured to mutually convert the positive voltage (=E/2) received by point of connection 4b between IGBTs Q1, Q2 and the negative voltage (=−E/2) received by point of connection 4c between IGBTs Q3, Q4, and the AC voltage having (2N+1) voltage values which is received by output node 4a. The efficiency of uninterruptible power supply device 100 can be further improved by causing N to be greater than 2 to increase the number of levels of the voltage output from each of converter 3 and inverter 4.

Even when the number of unit converters 30 connected in series in the first multilevel circuit is increased, the configuration of IGBTs Q1 to Q4 and diodes D1 to D4 remains the same. In other words, the configuration of IGBTs Q1 to Q4 and diodes D1 to D4 is maintained regardless of the number of levels of voltages output from converter 3 and inverter 4. According to this, in DC voltage converter 6, there is no need to change the configuration of the multilevel circuit shown in FIG. 4 and the configuration of controller 10 shown in FIG. 6 according to the number of levels of the voltages output from converter 3 and inverter 4.

For example, the case where a multilevel circuit of diode-clamp scheme is applied to converter 3 and inverter 4 is considered here. The diode clamp scheme is a circuit scheme in which DC voltage E between DC line L1 and DC line L3 is equally divided by a plurality of capacitors connected in series, and an arbitrary voltage dividing point potential is cramped by a diode to obtain a multilevel output voltage. In this case, since the voltages of a plurality of capacitors become unbalanced, it is necessary to change the circuit configuration of DC voltage converter 6 and the configuration of controller 10 to compensate for the voltage imbalance.

Contrastingly, in the present embodiment, DC voltage converter 6 shown in FIG. 4 and controller 10 shown in FIG. 6 can be applied because the DC input voltages of converter 3 and inverter 4 are maintained at a positive voltage, a neutral point voltage, and a negative voltage, regardless of the number of levels of voltages output from converter 3 and inverter 4. Thus, DC voltage converter 6 can be prevented from becoming more complicated according to the number of levels of voltages output from converter 3 and inverter 4.

### [Example Configuration of First Multilevel Circuit]

The above embodiment has described an example configuration of a first multilevel circuit including a plurality of series-connected unit converters 30, but the configuration of the first multilevel circuit is not limited thereto. For example, the first multilevel circuit can be configured using a flying capacitor.

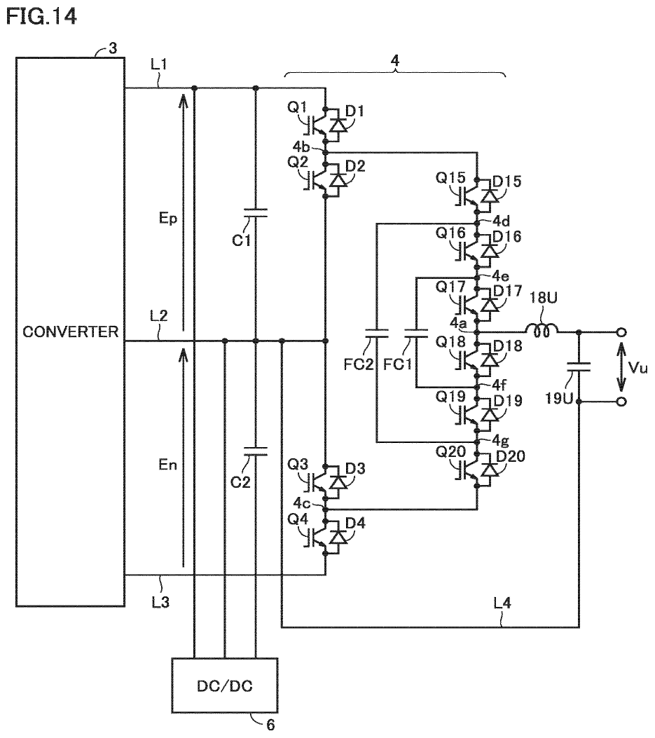

FIG. 14 is a circuit diagram showing an example configuration of inverter 4 and its peripherals shown in FIG. 1, which is compared with FIG. 3. In FIG. 14, only the circuit part corresponding to one phase (e.g., U phase) of three phases (U phase, V phase, W phase) is shown for simplification of the drawing and description.

As shown in FIG. 14, the first multilevel circuit includes IGBTs Q15 to Q20, diodes D15 to D20, and flying capacitors FC1, FC2.

IGBTs Q15 to Q20 are connected in series between point of connection 4b between IGBTs Q1, Q2 and point of connection 4c between IGBTs Q3, Q4. In FIG. 14, IGBTs Q15 to Q17 are connected in series between point of connection 4b and output node 4a (AC terminal) of inverter 4, and IGBTs Q18 to Q20 are connected in series between output node 4a and point of connection 4c. IGBTs Q15 to Q17 correspond to an embodiment of the “fifth switching element”, and IGBTs Q18 to Q20 correspond to an embodiment of the “sixth switching element”. Output node 4a is connected to the first terminal of reactor 18U. Diodes D15 to D20 are connected in anti-parallel to IGBTs Q15 to Q20, respectively.

Flying capacitor FC1 is connected between a point of connection 4e between IGBTs Q16, Q17 and a point connection between 4f between IGBTs Q18, Q19. Flying capacitor FC2 is connected between a point of connection 4d between IGBTs Q15, Q16 and a point of connection 4g between IGBTs Q19, Q20.

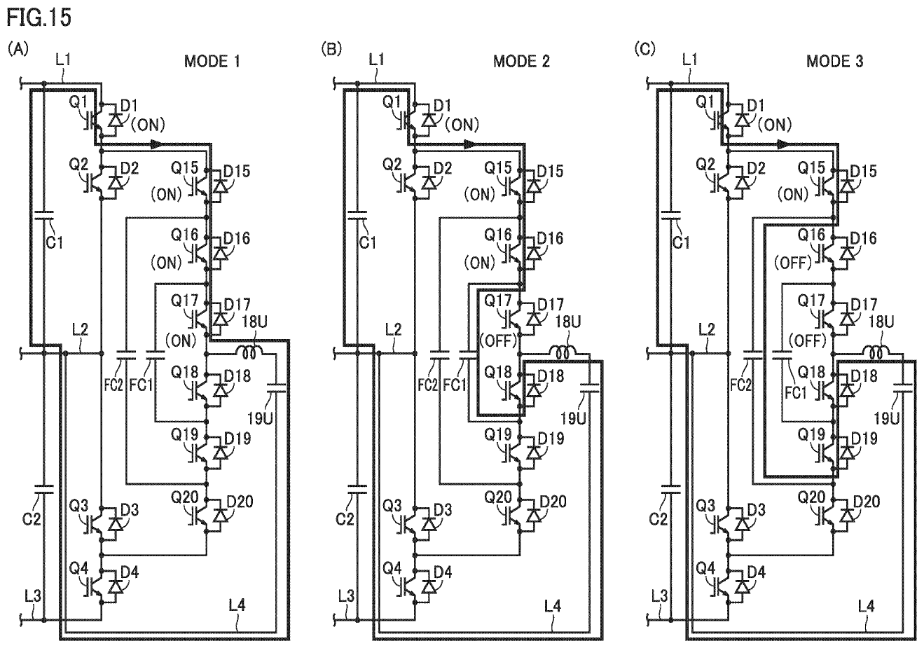

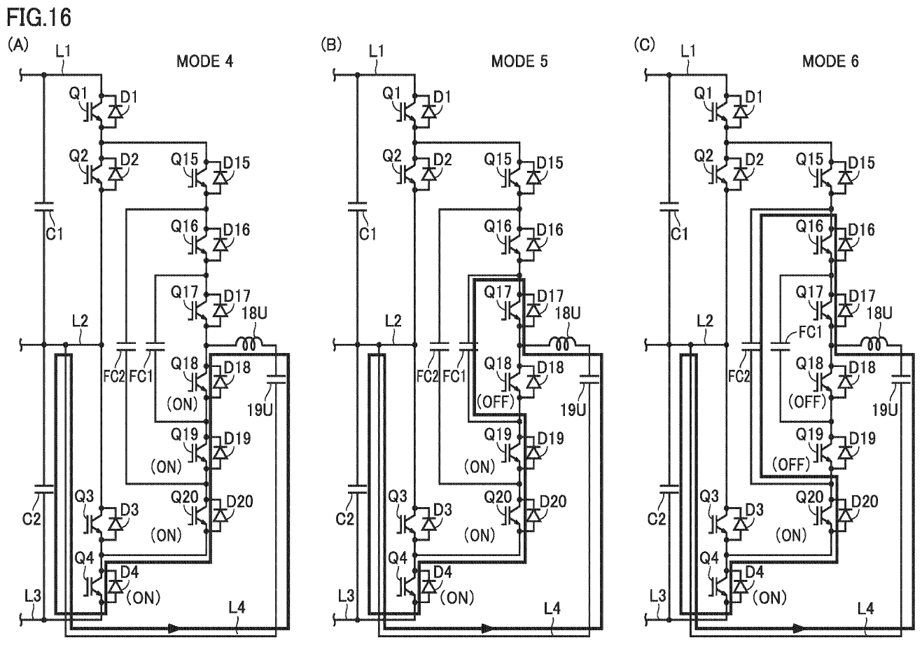

FIGS. 15 and 16 are circuit diagrams showing an operation of inverter 4 shown in FIG. 14 in each mode. Inverter 4 can assume six states from mode 1 to mode 6. During the first period in which voltage command value Vu* has positive polarity, inverter 4 can assume three states of mode 1 to mode 3. During the second period in which voltage command value Vu* has negative polarity, inverter 4 can assume three states of mode 4 to mode 6.

FIG. 15(A) shows mode 1. In mode 1, IGBTs Q1, Q15 to Q17 are turned on. During the first period (mode 1 to mode 3), IGBTs Q2 to Q4, Q18 to Q20 are fixed in the OFF state. A current flows in the direction of the arrow from DC line L1 to DC line L2 through IGBTs Q1, Q15 to Q17, reactor 18U, capacitor 19U, and neutral point line L4. A positive voltage is output from output node 4a. When DC voltage Ep=E/2, the voltage “E/2” is output from output node 4a.

FIG. 15(B) shows mode 2. In mode 2, IGBTs Q1, Q15, Q16 are turned on and IGBT Q17 is turned off. A current flows in the direction of the arrow from DC line L1 to DC line L2 through IGBTs Q1, Q15, Q16, flying capacitor FC1, diode D18, reactor 18U, capacitor 19U, and neutral point line L4. When the voltage of flying capacitor FC1 is VF1, Ep−VF1 is output from output node 4a. When Ep=E/2 and VF1=E/4, the voltage “E/2” is output from output node 4a.

FIG. 15(C) shows mode 3. In mode 3, IGBTs Q1, Q15 are turned on and IGBTs Q16, Q17 are turned off. A current flows in the direction of the arrow from DC line L1 to DC line L2 through IGBTs Q1, Q15, flying capacitor FC2, diodes D18, D19, reactor 18U, capacitor 19U, and neutral point line L4. When the voltage of flying capacitor FC2 is VF2, Ep−VF2 is output from output node 4a. When Ep=E/2 and VF2=E/2, the voltage “0” is output from output node 4a. Thus, during the first period, either voltage “E/2”, “E/4”, or “0” is output from output node 4a.

FIG. 16(A) shows mode 4. In mode 4, IGBTs Q4, Q18 to Q20 are turned on. During the second period (mode 4 to mode 6), IGBTs Q1 to Q3, Q15 to Q17 are fixed in the OFF state. A current flows in the direction of the arrow from DC line L2 to DC line L3 through neutral point line L4, capacitor 19U, reactor 18U, and IGBTs Q18 to Q20, Q4. A negative voltage (=−En) is output from output node 4a. When En=E/2, the voltage “−E/2” is output from output node 4a.

FIG. 16(B) shows mode 5. In mode 5, IGBTs Q19, Q20 are turned on and IGBT Q18 is turned off. A current flows in the direction of the arrow from DC line L2 to DC line L3 through neutral point line L4, capacitor 19U, reactor 18U, diode D17, flying capacitor FC1, and IGBTs Q19, Q20, Q4. −En+VF14 is output from node 4a. When En=E/2 and VF1=E/4, the voltage “−E/4” is output from output node 4a.

FIG. 16(C) shows mode 6. In mode 6, IGBT Q20 is turned on and IGBTs Q18, Q19 are turned off. A current flows in the direction of the arrow from DC line L2 to DC line L3 through neutral point line L4, capacitor 19U, reactor 18U, diodes D17, D16, flying capacitor FC2, and IGBTs Q20, Q4. −En+VF2 is output from node 4a. When En=E/2 and VF2=E/2, the voltage “0” is output from output node 4a. Thus, during the second period, either voltage “0”, “−E/4”, or “−E/2” is output from output node 4a.

The first multilevel circuit shown in FIG. 14 is configured to mutually convert the positive voltage (=E/2) received by point of connection 4b between IGBTs Q1, Q2 and the negative voltage (=−E/2) received by point of connection 4c between IGBTs Q3, Q4, and the AC voltage (E/2, E/4, 0, −E/4, −E/2) having five voltage values which is received by output node 4a. Thus, by applying the first multilevel circuit shown in FIG. 14 to each of converter 3 and inverter 4, switching losses of the IGBTs in converter 3 and inverter 4 can be reduced, and iron losses of reactors 12, 18 included in AC input filter 2 and AC output filter 5, respectively, can be reduced. As a result, higher efficiency of uninterruptible power supply device 100 can be achieved.

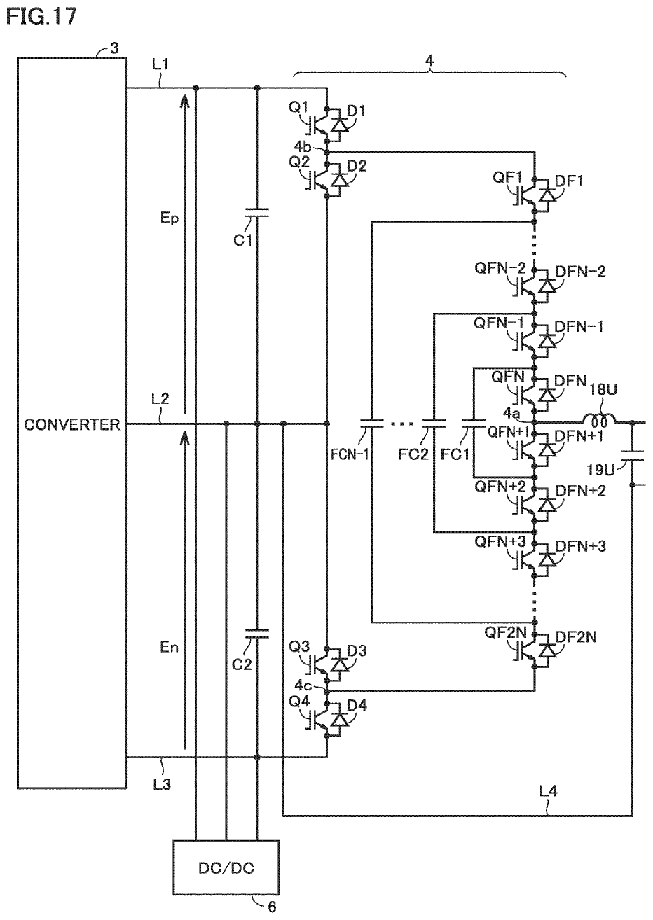

By further increasing the number of IGBTs and flying capacitors that constitute the first multilevel circuit, the number of levels of voltage output from inverter 4 can be further increased. FIG. 17 is a circuit diagram showing an example configuration of inverter 4 and its peripherals. The first multilevel circuit shown in FIG. 17 includes 2N IGBTs QF1 to QF2N, 2N diodes DF1 to DF2N, and (N−1) flying capacitors FC1 to FCN−1, where N is an integer greater than or equal to 2.

As shown in FIG. 17, IGBTs QF1 to QF2N are connected in series between point of connection 4b between IGBTs Q1, Q2 and point of connection 4c between IGBTs Q3, Q4. The point of connection between IGBTs QFN, QFN+1 is connected to output node 4a of inverter 4. IGBTs Q1, Q2 and IGBTs QF1 to QFN constitute the upper arm. IGBTs Q3, Q4 and IGBTs QFN+1 to QF2N constitute the lower arm. Diodes DF1 to DF2N are connected in anti-parallel to IGBTs QF1 to QF2N, respectively.

Flying capacitor FC1 is connected between the point of connection between a first IGBT QFN and a second IGBT QFN−1 toward point of connection 4b as viewed from output node 4a, and the point of connection between a first IGBT QFN+1 and a second IGBT QFN+2 toward point of connection 4c as viewed from output node 4a.

Flying capacitor FC2 is connected between the point of connection between a second IGBT QFN−1 and a third IGBT QFN−2 toward point of connection 4b as viewed from output node 4a, and the point of connection between a second IGBT QFN+2 and a third IGBT QFN+3 toward point of connection 4c as viewed from output node 4a.

Flying capacitor FCN−1 is connected between the point of connection between an (N−1)th IGBT QF2 and an N-th IGBT QF1 toward point of connection 4b as viewed from output node 4a, and the point of connection between an (N−1)th IGBT QF2N−1 and an N-th IGBT QF2N toward point of connection 4c as viewed from output node 4a.

In other words, when M is such an integer that 1≤M≤N−1, an M-th flying capacitor FCM is connected between the point of connection between an M-th IGBT QFN−M+1 and an (M+1)th IGBT QFN−M toward point of connection 4b as viewed from output node 4a, and the point of connection between an M-th IGBT QFN+M and an (M+1)th IGBT QFN+M+1 toward point of connection 4c as viewed from output node 4a.

In this configuration, flying capacitors FC1 to FCN−1 hold voltages different from each other. When the voltage of M-th flying capacitor FCM is VFM, VFM is M/(N−1) times E/2 (VFM=E×M/2 (N−1)).

The first multilevel circuit shown in FIG. 17 is configured to mutually convert the positive voltage (=E/2) received by point of connection 4b between IGBTs Q1, Q2 and the negative voltage (=−E/2) received by point of connection 4c between IGBTs Q3, Q4, and an AC voltage having (2N−1) voltage values which is received by output node 4a.

As shown in FIG. 17, even when the number of IGBTs and flying capacitors included in the first multilevel circuit is increased, the configurations of IGBTs Q1 to Q4 and diodes D1 to D4 remain the same. Thus, regardless of the number of levels of voltages output from converter 3 and inverter 4, the DC input voltages of converter 3 and inverter 4 are maintained at a positive voltage, a neutral point voltage, and a negative voltage, and accordingly, DC voltage converter 6 shown in FIG. 4 can be applied.

It should be understood that the embodiment disclosed herein is illustrative and non-restrictive in every respect. The present disclosure is defined by the scope of the claims, rather than the description on the embodiment above, and is intended to include any modifications within the meaning and scope equivalent to the scope of the claims.

### REFERENCE SIGNS LIST

1 switch; 2 AC input switch; 3 converter; 4 inverter; 5 AC output filter; 6 DC voltage converter; 10 controller; 11, 19 capacitor; 12, 18, 22 reactor; 21 semiconductor switch; 24, 32, 37 current detector; 25, 31, 34 to 36 voltage detector; 30 unit converter; 33 power failure detector; 41 commercial AC power supply; 42 load; 51, 71, 91 voltage command generation circuit; 52, 72 balance control circuit; 53A to 53C, 68A to 68C, 73A, 97U, 97V, 97W adder; 54 determiner; 55, 75, 92 PWM circuit; 356 to 358 NOT circuit; 374, 375 AND circuit; 61, 81, 93 reference voltage generation circuit; 62, 66A to 66C, 73B, 82, 84, 95U, 95V, 95W subtractor; 63 DC voltage control circuit; 64 sine wave generation circuit; 65A to 65C multiplier; 67, 85, 96 current control circuit; 83, 94 voltage control circuit; 100 uninterruptible power supply device; 350 carrier wave generation circuit; 351 to 355 comparator; 360 to 371 buffer; 372, 373 delay circuit; B1 battery; Cu1 to Cu4 carrier wave; D1 to D20, DF1 to DF2N, D1D to D4D diode; FC1 to FCN−1 flying capacitor; L1 to L3 DC line; L4 neutral point line; Q1 to Q20, Q1D to Q4D, QF1 to QF2N IGBT.

1. A power conversion device comprising:
a first direct-current (DC) line, a second DC line, and a third DC line;
a first capacitor connected between the first and second DC lines;
a second capacitor connected between the second and third DC lines;
a power converter configured to mutually convert a first DC voltage, a second DC voltage, and a third DC voltage respectively supplied from the first to third DC lines, and a first alternate-current (AC) voltage having at least five voltage values; and
a filter that removes a harmonic caused by the power converter, wherein
the power converter includes
a first switching element and a second switching element connected in series between the first and second DC lines,
a third switching element and a fourth switching element connected in series between the second and third DC lines,
an AC terminal that receives the first AC voltage, and
a first multilevel circuit connected between the AC terminal, and a first point of connection and a second point of connection, the first point of connection being a point of connection between the first and second switching elements, the second point being a point of connection between the third and fourth switching elements,
the filter includes
a first reactor having a first terminal connected to the AC terminal, and
a third capacitor connected between a second terminal of the first reactor and the second DC line, and
the first multilevel circuit mutually converts the first AC voltage, and the first and third DC voltages, the first DC voltage being received by the first point of connection, the third DC voltage being received by the second point of connection.

2. The power conversion device according to claim 1, further comprising a DC voltage converter that bidirectionally performs voltage conversion between a power storage device and the first to third DC lines,
wherein the DC voltage converter includes a second multilevel circuit that mutually converts a fourth DC voltage supplied from the power storage device and the first to third DC voltages.

3. The power conversion device according to claim 1, wherein the first reactor is an air-core reactor.

4. The power conversion device according to claim 1, wherein
the first to fourth switching elements are a first insulated gate bipolar transistor, a second insulated gate bipolar transistor, a third insulated gate bipolar transistor, and a fourth insulated gate bipolar transistor, respectively, and
the power conversion device further comprises a first diode, a second diode, a third diode, and a fourth diode connected in anti-parallel to the first to fourth insulated gate bipolar transistors, respectively.

5. The power conversion device according to claim 1, wherein
the first multilevel circuit includes
N first unit converters connected in series between the first point of connection and the first terminal of the first reactor, and
N second unit converters connected in series between the second terminal of the first reactor and the second point of connection, N being an integer greater than or equal to two, and
the first multilevel circuit mutually converts the first and second DC voltages, and the first AC voltage, the first DC voltage being received by the first point of connection, the second DC voltage being received by the second point of connection, the first AC voltage being received by the AC terminal and having (2N+1) voltage values.

6. The power conversion device according to claim 5, wherein each of the first unit converter and the second unit converter includes
a half-bridge circuit, and
an energy storage element connected in parallel to the half-bridge circuit.

7. The power conversion device according to claim 5, further comprising a controller that controls the power converter in accordance with a pulse width modulation (PWM) method,
wherein the controller includes
a voltage command generation circuit that generates a voltage command value of sinusoidal shape,
a carrier wave generator that generates 2N carrier waves obtained by evenly superimposing a DC offset upon a maximum amplitude of the voltage command value,
a first comparator that compares the voltage command value with the 2N carrier waves and generates a control signal for controlling the N first unit converters and the N second unit converters, and
a second comparator that generates a control signal for turning on the first switching element during a first period in which the voltage command value has positive polarity and turning on the fourth switching element during a second period in which the voltage command value has negative polarity.

8. The power conversion device according to claim 1, wherein
the first multilevel circuit includes
N fifth switching elements connected in series between the first point of connection and the AC terminal,
N sixth switching elements connected in series between the AC terminal and the second point of connection, and
(N−1) flying capacitors,
an M-th flying capacitor of the (N−1) flying capacitors is connected between (i) a point of connection between an M-th fifth switching element and an (M+1)th fifth switching element among the N fifth switching elements toward the first point of connection as viewed from the AC terminal, and (ii) a point of connection between an M-th sixth switching element and an (M+1)th sixth switching element among the N sixth switching elements toward the second point of connection as viewed from the AC terminal, M being an integer greater than or equal to 1 and smaller than or equal to N−1, and
the first multilevel circuit mutually converts the first and second DC voltages, and the first AC voltage, the first DC voltage being received by the first point of connection, the second DC voltage being received by the second point of connection, the first AC voltage being received by the AC terminal and having (2N−1) voltage values.

9. The power conversion device according to claim 8, wherein the M-th flying capacitor holds a voltage M/N−1 times the first DC voltage.

10. The power conversion device according to claim 8, wherein
the N fifth switching elements and the N sixth switching elements are N fifth insulated gate bipolar transistors and N sixth insulated gate bipolar transistors, respectively, and
the first multilevel circuit further includes
N fifth diodes respectively connected in anti-parallel to the N fifth insulated gate bipolar transistors, and
N sixth diodes respectively connected in anti-parallel to the N sixth insulated gate bipolar transistors.

11. The power conversion device according to claim 2, wherein the second multilevel circuit includes
a seventh switching element and an eighth switching element connected in series between the first DC line and the second DC line,
a ninth switching element and a tenth switching element connected in series between the second DC line and the third DC line,
a second reactor connected between a point of connection between the seventh and eighth switching elements and a positive electrode of the power storage device, and
a third reactor connected between a point of connection between the ninth and tenth switching elements and a negative electrode of the power storage device.

12. The power conversion device according to claim 1, wherein the power converter is an inverter that is connected between the first to third DC lines and a load, converts DC power supplied from the first to third DC lines into AC power, and supplies the AC power to the load.

13. The power conversion device according to claim 1, wherein the power converter is a converter that is connected between an AC power supply and the first to third DC lines, converts AC power from the AC power supply into DC power and supplies the DC power to the first to third DC lines during normal operation of the AC power supply.

14. The power conversion device according to claim 2, wherein
the power converter is a converter that is connected between an AC power supply and the first to third DC lines, and converts AC power from the AC power supply into DC power and supplies the DC power to the first to third DC lines during normal operation of the AC power supply, and
the DC voltage converter stores the DC power generated by the converter in the power storage device during normal operation of the AC power supply, and supplies the DC power of the power storage device to the first to third DC lines during a power failure of the AC power supply.

15. The power conversion device according to claim 2, wherein the first reactor is an air-core reactor.

16. The power conversion device according to claim 6, further comprising a controller that controls the power converter in accordance with a pulse width modulation (PWM) method,
wherein the controller includes
a voltage command generation circuit that generates a voltage command value of sinusoidal shape,
a carrier wave generator that generates 2N carrier waves obtained by evenly superimposing a DC offset upon a maximum amplitude of the voltage command value,
a first comparator that compares the voltage command value with the 2N carrier waves and generates a control signal for controlling the N first unit converters and the N second unit converters, and
a second comparator that generates a control signal for turning on the first switching element during a first period in which the voltage command value has positive polarity and turning on the fourth switching element during a second period in which the voltage command value has negative polarity.

17. The power conversion device according to claim 9, wherein
the N fifth switching elements and the N sixth switching elements are N fifth insulated gate bipolar transistors and N sixth insulated gate bipolar transistors, respectively, and
the first multilevel circuit further includes
N fifth diodes respectively connected in anti-parallel to the N fifth insulated gate bipolar transistors, and
N sixth diodes respectively connected in anti-parallel to the N sixth insulated gate bipolar transistors.

18. The power conversion device according to claim 2, wherein the power converter is an inverter that is connected between the first to third DC lines and a load, converts DC power supplied from the first to third DC lines into AC power, and supplies the AC power to the load.

19. The power conversion device according to claim 2, wherein the power converter is a converter that is connected between an AC power supply and the first to third DC lines, converts AC power from the AC power supply into DC power and supplies the DC power to the first to third DC lines during normal operation of the AC power supply.
